(19) United States
(12) Patent Application Publication
(10) Pub. No.: US 2008/0062126 A1
(43) Pub. Date: Mar. 13, 2008

(54) 3D method and system for hand-held devices

(76) Inventor: Cherif Atia Algreatly, Newark, CA (US)

Correspondence Address: CHERIF ATIA ALGREATLY;MATHEMATICAL INVENTING- SILICON VALLEY, SUITE 286, 39962 CEDAR BLVD, NEWARK, CA, 94560, US

(21) Appl. No.: 11/906,520

(22) Filed: Oct. 1, 2007

Related U.S. Application Data
(63) Continuation-in-part of application No. 11/564,882, filed on Nov. 30, 2006.
(63) Continuation-in-part of application No. 11/654,740, filed on Jan. 18, 2007.

(30) Foreign Application Priority Data
Jul. 6, 2006 (EG) PCT/EG2006/000025
Jun. 28, 2007 (EG) PCT/EG2007/000021

(51) Int. Cl. G06F 3/033; G06F 3/02; G06F 3/041

(52) U.S. Cl. 345/157; 345/168; 345/173

(57) ABSTRACT

A 3D input method and system that enables the user to interact with various 3D applications on the hand-held device's display. The 3D input method is based on utilizing five positions that can be five spots on a touch screen such as that of the iPhone, or a 5-way button that is usually included on the hand-held device's keyboard, or any adjacent five buttons arranged in a symmetrical cross-configuration on a hand-held device's keyboard. Said five positions provide six degrees-of-freedom to manipulate a pointer to move in 3D on a hidden mesh grid that covers a 3D virtual environment on the hand-held device's display. Accordingly, the user is able to move or navigate in 3D using a single finger of a hand in an intuitive manner to operate 3D windows, 3D GPS, virtual reality, 3D games, or the like.

### CROSS-REFERENCE TO RELATED APPLICATION

This application is a Continuation-in-Part of co-pending International Applications No. PCT/EG2006/000025, filed Jul. 6, 2006, and No. PCT/EG2007/000021, filed Jun. 28, 2007, and U.S. patent applications Ser. No. 11/564,882, filed Nov. 30, 2006, and No. 11/654,740 filed Jan. 18, 2007.

### BACKGROUND

The commercial demand for using different three-dimensional applications on the display of the hand-held devices is growing. The 3D interfaces for the mobile phones, the 3D building models for GPS units, and the 3D virtual environments and characters for gaming devices are examples of such three-dimensional applications.

Such three-dimensional applications were limited to the computer, where the 3D mice, the navigation devices, and the game controllers help the computer user to move or navigate in three-dimensions on the computer display.

The operation of the hand-held devices is different from the computer, where using such 3D computer input devices requires the use of a surface for support which is not practical for the user of the hand-held devices. The hand-held device is mostly operated by its keyboard while the user is holding it in one hand, and in many cases the user may need to use the fingers of the same hand that holds the device to operate the keyboard.

In fact, the nature of the design of hand-held devices restricts the use of such 3D computer input devices, and confines the operation to the keyboard, making the interaction with the 3D applications too difficult for the users. This problem prevents the users from benefiting from the visual advantages of the 3D applications, and, accordingly, excludes many software developers and hardware manufacturers from supporting the 3D trend.

Obviously there is a real need for a distinct solution that solves the aforementioned problem, to simplify using three-dimensional applications for hand-held devices, and encourage users, software developers, and hardware manufacturers to support and maintain this 3D trend.

The present invention introduces a 3D input method and system for hand-held devices that solves the aforementioned problem, where the user can move or navigate in 3D on the hand-held device's display using one finger of a hand in an intuitive manner, as will be described subsequently.

### SUMMARY

The present invention provides a new 3D input method and system that enables the user of the hand-held devices to interact with different 3D applications. The 3D input method is based on utilizing five positions, these five positions can be five spots on a touch screen such as that of the iPhone, or can be a 5-way button that is usually included on the hand-held device's keyboard. Also, any adjacent five buttons arranged in a symmetrical cross-configuration on a device's keyboard can be used as an alternative to the suggested 5-way button.

Each touch or pressing on one of the five positions generates a unique signal indicating that a specific position has been pressed. Two specific successive pressings on one or two positions represent one degree-of-freedom, where six different alternatives of said two successive pressings provide six degrees of freedom. The six degrees of freedom represent a movement along or rotation about the x, y, or z-axis of the Cartesian coordinate system. The x and y-axis represent, respectively, the horizontal direction (east-west) and the vertical direction (north-south) of the hand-held device's display.

There is a pointer on the hand-held device's display that targets a specific spot in a virtual 3D environment. The pointer is comprised of a line connecting two points, a base-point and an endpoint, with the base-point located in the center of the hand-held device's display, much like the intersecting origin point of the x-axis and the −y axis. The endpoint protrudes radially (with the ability to both protract and retract) from the base-point and rotates when the base-point is rotated about its origin. The radial protrusion (or endpoint) is then located wherever the endpoint intersects with the 3D virtual environment on the device's display.

The pointer and the virtual camera can be moved or rotated simultaneously in three-dimensions on the hand-held device's display when one of the six degrees of freedom is provided. It is also possible to rotate the pointer independently without moving the virtual camera.

Any spot in the virtual 3D environment on the hand-held device's display can be targeted by the radial protrusion when the base-point is rotated. This spot can be an icon, menu, or any object in 3D that interacts with the user (or becomes “live”) when s/he presses the “Enter” or “OK” button on the hand-held device's keyboard while the pointer is targeting the spot.

The virtual 3D environment on the hand-held device's display is divided by hidden horizontal and vertical lines that intersect with each other. Each intersection is considered a node, where a plurality of intersections (or nodes) forms a mesh grid. Each node has a unique ID and identified position in three-dimensions. When the pointer is moved or rotated to target various spots of the virtual 3D environment, the endpoint moves from one node on the grid to another. Using this concept of moving the endpoint on identified nodes, in addition to knowing the radial orientation or rotational values of the base-point, eases the detection/identification or calculation of which node is being targeted by the pointer.

Each icon, menu, or object in the 3D virtual environment that may be targeted to interact with the pointer needs at least one node to be located inside it, where, by definition, the pointer reaches said icon, menu, or object when it reaches this “internal node.” The type of interaction may vary from just clicking on an icon or menu, moving an object in 3D, or editing an object in 3D which would be strictly defined as changing its properties (dimensions, shape, etc.).

The previous summary describes briefly the present 3D input method and system for hand-held devices. The following description provides more details, examples, and applications for the present invention.

### BRIEF DESCRIPTION OF THE DRAWINGS

FIG. 1 is a 5-way button comprised of five positions +x, −x, +y, −y, and z to provide six degrees of freedom.

FIG. 2 is an illustration for the x, y, and z-axis of the Cartesian coordinate system.

FIG. 3 is a table indicates the user's finger pressing on the 5-way button to provide a movement along the x, y, or z-axis.

FIG. 4 is a table indicates the user's finger pressing on the 5-way button to provide a rotation about the x, y, or z-axis.

FIG. 5.1 is the pointer of the present invention targeting a cube on a hand-held device's display.

FIGS. 5.2 to 5.13 are illustrations for moving or rotating the pointer and the virtual camera in 3D on a hand-held device's display.

FIG. 6 is an example for a cube on a hand-held device's display divided by hidden horizontal and vertical lines to form a mesh grid.

FIG. 7 is a diagrammatic illustration for the main three elements of the present invention.

FIG. 8.1 is the pointer of the present invention targeting a cylinder on a hand-held device's display.

FIGS. 8.2 to 8.13 are illustrations for moving or rotating the cylinder in 3D on the hand-held device's display.

FIG. 9 is an example for using a virtual reality application on a hand-held device's display.

FIG. 10 is an example for an innovative 3D interface presented on a hand-held device's display.

### DETAILED DESCRIPTION

The present 3D input system for hand-held devices is comprised of three main elements. The first element is the 3D input method that provides six degrees of freedom. The second element is the pointer which moves radially or rotates on the hand-held device's display to target a specific object in a 3D virtual environment. The third element is the mesh grid that the pointer moves on to reach its target in 3D on the hand-held device's display.

The first element of the present invention is the 3D input method that provides six degrees of freedom by utilizing five positions, these five positions can be five spots on a touch screen of an iPhone, or can be the five orientations of a 5-way button (north, east, west, south, and downward). Also, the five positions can also be five buttons arranged in a cross-configuration on a hand-held device's keyboard as will be described subsequently.

The first degree of freedom represents a movement along the x-axis of the device's display. The second degree of freedom represents a movement along the y-axis of the device's display. The third degree of freedom represents a movement along the direction of the pointer in 3D on the device's display. The fourth degree of freedom represents a rotation about the x-axis of the device's display. The fifth degree of freedom represents a rotation about the y-axis of the device's display. The sixth degree of freedom represents a rotation about the pointer.

The x-axis of the device's display represents the horizontal direction (east-west) of the hand-held device's display, while the y-axis of the device's display represents the vertical direction (north-south) of the hand-held device's display.

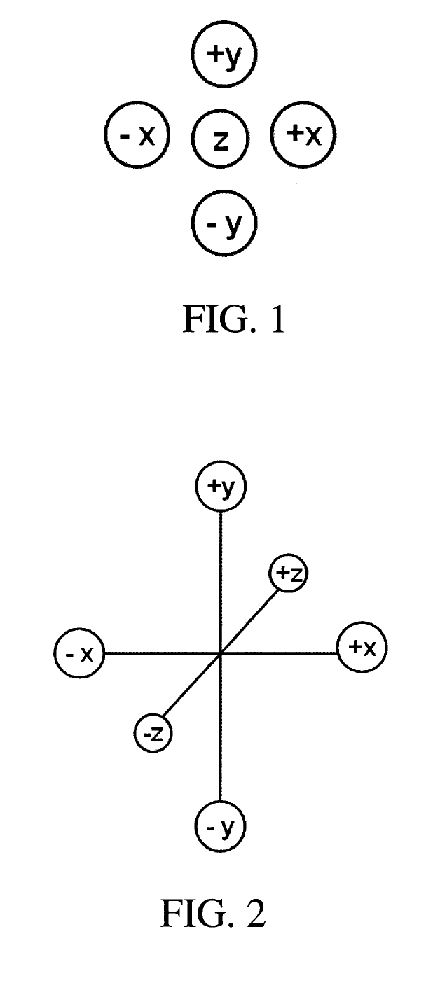

FIG. 1 illustrates a 5-way button comprised of five positions +x, −x, +y, −y, and z that are located on the east, west, north, south, and center of the 5-way button. These five positions represent the side view of the x, y, and z-axis directions of the Cartesian coordinate system that are illustrated in FIG. 2.

For example, the “+x” position represents the positive direction of the x-axis. The “−x” position represents the negative direction of the x-axis. The “+y” position represents the positive direction of the y-axis. The “−y” position represents the negative direction of the y-axis. The “z” position represents both of the positive and negative directions of the z-axis.

Each pressing on one of the five positions of the 5-way button generates a unique signal indicating a specific position is pressed. Each two different successive pressings on one or two positions of said 5-way button generate two unique successive signals that represent one degree of the six degrees freedom.

For example, the user's finger is moved horizontally to press on the “−x” position then the “+x” position to represent a movement along the positive x-axis. The user's finger is moved horizontally to press on the “+x” position then the “−x” position to represent a movement along the negative x-axis. The user's finger is moved vertically to press on the “−y” position then the “+y” position to represent a movement along the positive y-axis. The user's finger is moved vertically to press on the “+y” position then the “−y” position to represent a movement along the negative y-axis. The user's finger is moved vertically to press on the “z” position then the “+y” position to represent a movement along the positive z-axis. The user's finger is moved vertically to press on the “z” position then the “−y” position to represent a movement along the negative z-axis.

The previous operation of moving the user's finger on the five positions of the 5-way button logically matches the movement along the x, y, and z-axis. Where to move in the positive or negative directions of the x-axis, the user moves his finger horizontally, respectively, from “left” to “right”, or from “right” to “left”. To move in the positive or negative directions of the y-axis, the user moves his/her finger vertically, respectively, from “down” to “up”, or from “up” to “down”. To move in the positive or negative directions of the z-axis the user moves his/her finger vertically, respectively, from “down” to “up”, or from “up” to “down”. To make the user's finger distinguish the difference while moving along the y-axis or the z-axis, the height of the “z” position is lower than the height of the “y” positions as will be described subsequently.

To rotate about the x-axis; the user presses twice on the “+y” position to represent a clockwise rotation about the x-axis, or presses twice on the “−y” position to represent a counter-clockwise rotation about the x-axis. To rotate about the y-axis; the user presses twice on the “+x” position to represent a clockwise rotation about the y-axis, or presses twice on the “−x” position to represent a counter-clockwise rotation about the y-axis.

To rotate about the z-axis; the user moves his/her finger clockwise to press, respectively, on any two successive positions such as the “+y and +x”, the “+x and −y”, the “−y and −x”, or the “−x and +y” to represent a clockwise rotation about the z-axis. The user moves his/her finger counter-clockwise to press, respectively, on any two successive positions such as the “+y and −x”, the “−x and −y”, the “−y and +x”, or the “+x and +y” to represent a counter-clockwise rotation bout the z-axis.

Obviously the previous operation of pressing or moving the user's finger logically matches the sense of rotating about the x, y, and z-axis. Where the double-pressing gives the user a feeling of exercising additional weight on specific sides of the 3D cross of FIG. 2 making the pressed position rotate around the x, or y-axis. While rotating about the z-axis by moving the user's finger clockwise or counter-clockwise around the z position gives the user a perfect sense of rotating about the z-axis, clockwise or anti-clockwise.

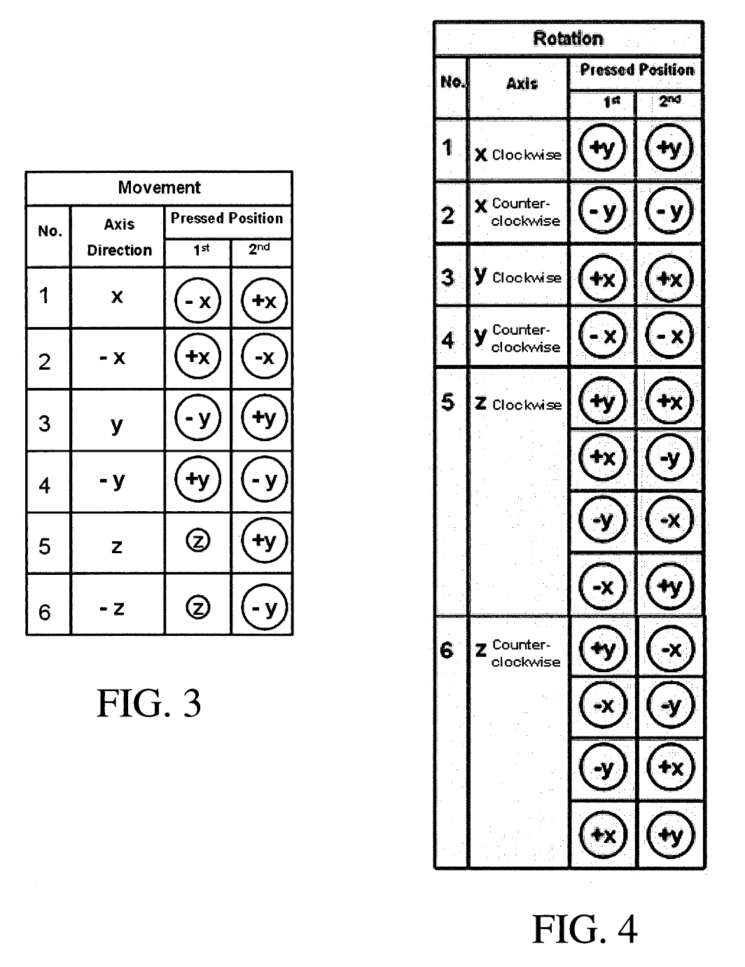

FIG. 3 illustrates a table that indicates the user's finger movement or pressing on the five positions of the 5-way button to represent moving along the x, y, or z-axis. FIG. 4 illustrates another table that indicates the user's finger movement or pressing on the five positions of the 5-way button to represent rotating about the x, y, or z-axis. As shown in these two tables each degree of freedom is provided by one alternative of the user's finger movement or pressing, except rotating about the z-axis which can be provided by four different alternatives of the user finger's movements.

This intuitiveness in moving along or rotating about the x, y, z-axis matches the human nature in sensing the three dimensional directions while using the method of the present invention which makes the user master the method in a minimal time. In addition to, using a single finger of a hand makes the present method much easier for the user.

Generally, operating said 5-way button requires the “+x”, “−x”, “+y”, and “−y” positions to have elevated level than the “z” position. This is to achieve two goals: the first goal is to avoid hitting the “z” position by mistake while moving the user's finger from the “+x” to the “−x” position or vice versa, or from the “+y” to “−y” position or vice versa. The second goal is to make the user distinguish the difference between moving in the y-axis or the z-axis, where the height of the “z” position is lower than the “y” position and the “−y” position. However, most of the 5-way buttons that are included on the hand-held device's keyboard have such dual-level configuration.

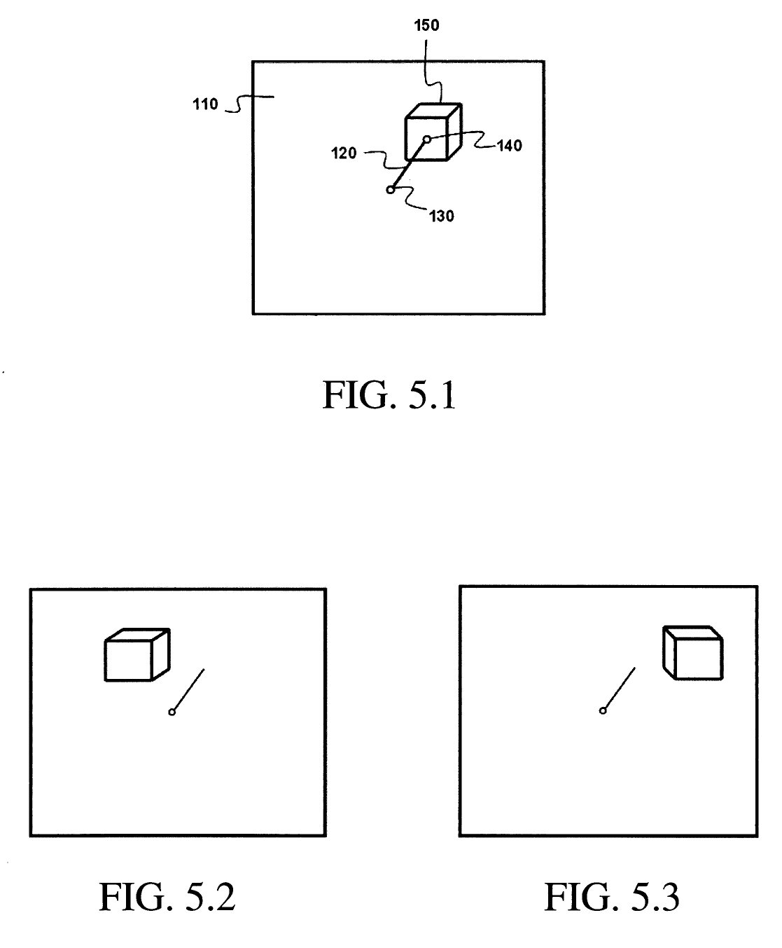

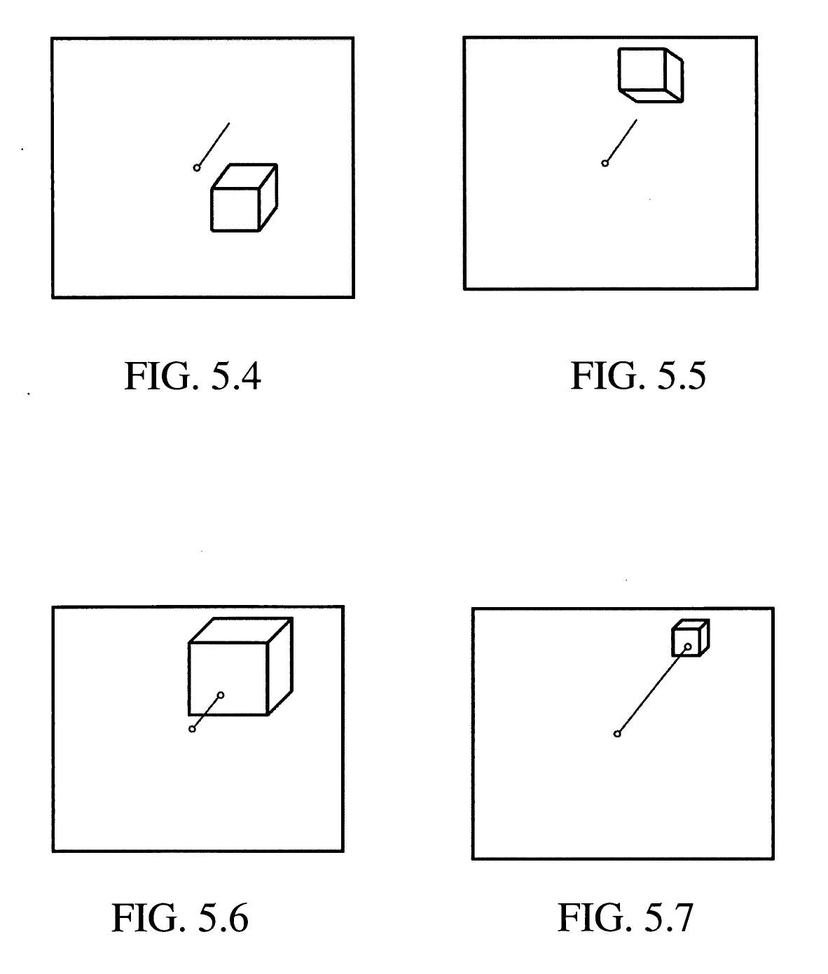

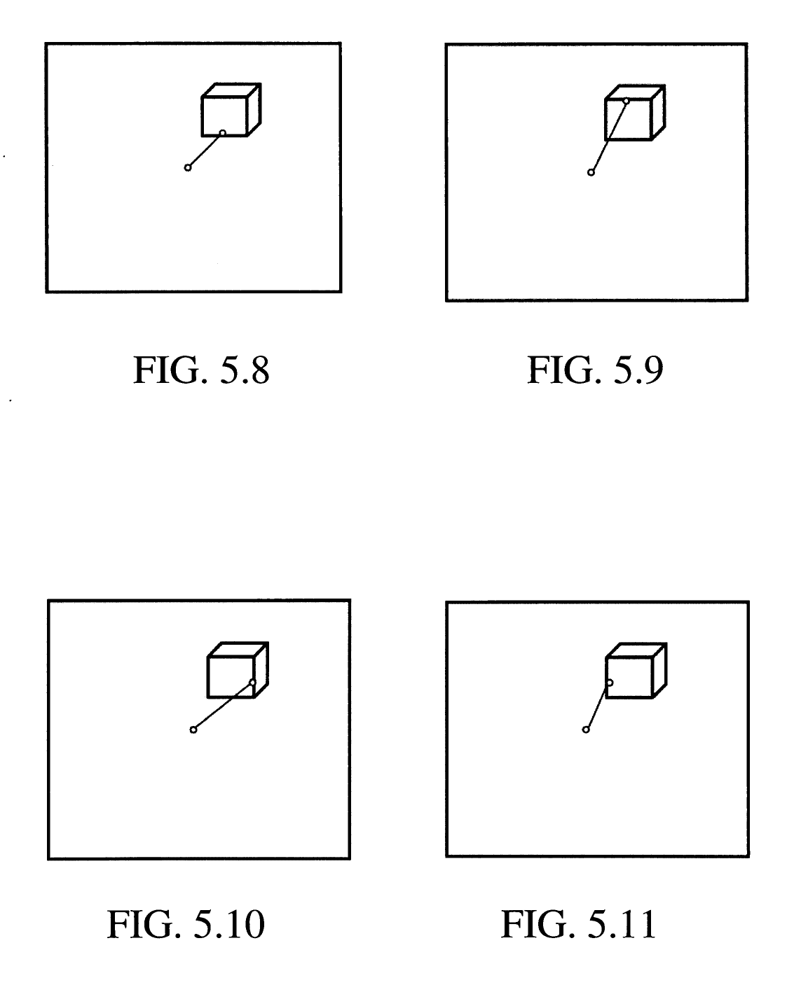

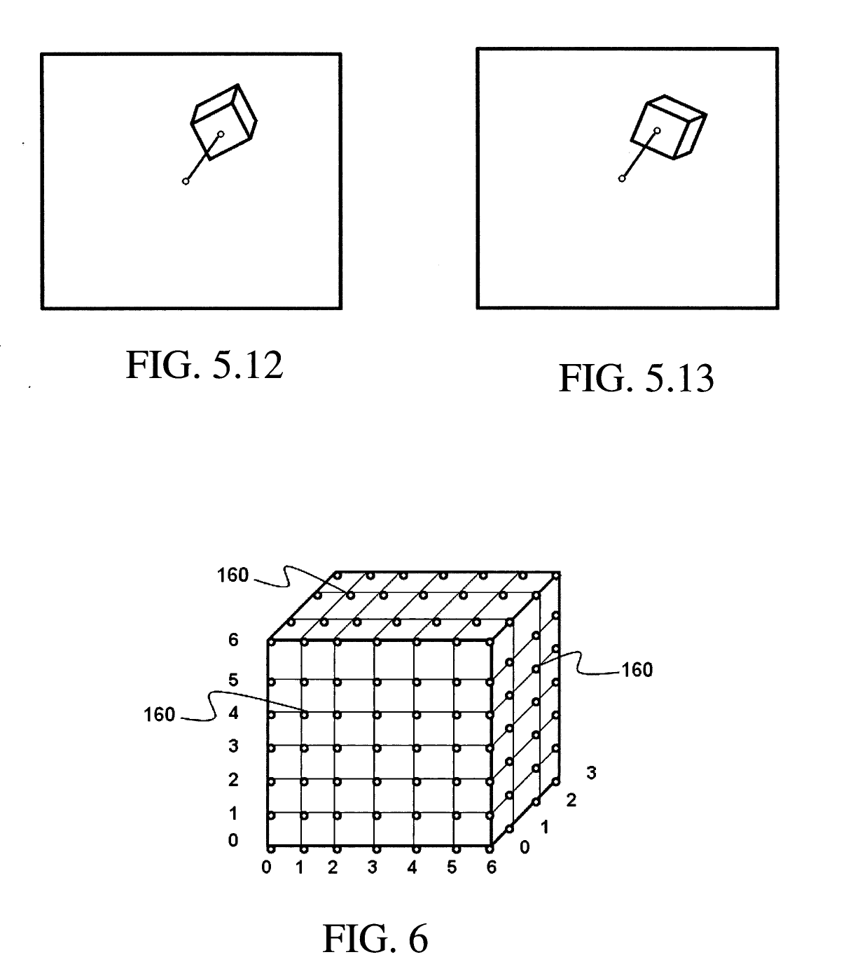

The second element of the present invention is the pointer which is illustrated in FIG. 5.1. As shown in this figure, the pointer appears on a hand-held device's display 110, it is comprised of a line 120 connecting two points or ends, the first end is a base-point 130 which is located in the center of the hand-held device's display, and the second end is an endpoint 140 which is located on one of the nodes of the 3D virtual environment. In this figure, the pointer is targeting a cube 150 on the hand-held device's display.

Each degree of freedom provided by the 5-way button manipulates the pointer and the virtual camera to move or rotate in specific direction on the hand-held device's display. For example, providing a movement along the positive x-axis, moves the pointer and the virtual camera along the positive x-axis of the hand-held device's display as illustrated in FIG. 5.2. Providing a movement along the negative x-axis, moves the pointer and the virtual camera along the negative x-axis of the hand-held device's display as illustrated in FIG. 5.3.

Providing a movement along the positive y-axis, moves the pointer and the virtual camera along the positive y-axis of the hand-held device's display as illustrated in FIG. 5.4. Providing a movement along the negative y-axis, moves the pointer and the virtual camera along the negative y-axis of the hand-held device's display as illustrated in FIG. 5.5.

Providing a movement along the positive z-axis, moves the virtual camera forward, parallel to the direction of the pointer in 3D on the hand-held device's display as illustrated in FIG. 5.6. Provide a movement along the negative z-axis, moves the virtual camera backward, parallel to the direction of the pointer in 3D on the hand-held device's display as illustrated in FIG. 5.7.

Providing a clockwise rotation about the x-axis, rotates the pointer and the virtual camera clockwise about the x-axis of the hand-held device's display as illustrated in FIG. 5.8. Providing a counter-clockwise rotation about the x-axis, rotates the pointer and the virtual camera counter-clockwise about the x-axis of the hand-held device's display as illustrated in FIG. 5.9.

Providing a clockwise rotation about the y-axis, rotates the pointer and the virtual camera clockwise about the y-axis of the hand-held device's display as illustrated in FIG. 5.10. Providing a counter-clockwise rotation about the y-axis, rotates the pointer and the virtual camera counter-clockwise about the x-axis of the hand-held device's display as illustrated in FIG. 5.11.

Providing a clockwise rotation about the z-axis, rotates the virtual camera clockwise about the pointer as illustrated in FIG. 5.12. Providing a counter-clockwise rotation about the z-axis, rotates the virtual camera counter-clockwise about the pointer as illustrated in FIG. 5.13.

The third element of the present invention is the mesh grid, which is a result of intersected hidden lines parallel to the x, y, and z-axis of the 3D virtual environment on the hand-held device's display. Each intersection is considered as one node, each node can be defined with a unique ID and an identified position in three dimensions (x, y, z).

For example, FIG. 6 illustrates a cube divided by a plurality of intersected hidden lines parallel to the x, y, and z-axis to form a number of nodes 160. As shown in the figure; the cube indicates numerals that represent the coordinates of the x, y, and z-axis. The mesh grid enables the endpoint of the pointer to target any spot in the virtual 3D environment on the hand-held device's display without any complex mathematical calculations.

For example, if the endpoint of the pointer is intersected with the cube in node (0, 0, 0) and the pointer is rotated clockwise about the y-axis of the hand-held device's display, then the endpoint of the pointer will be moved parallel to the xy-plane of the cube, respectively, on nodes (1, 0, 0), (2, 0, 0), (3, 0, 0), (4, 0, 0), (5, 0, 0), (6, 0, 0), (6, 1, 0), (6, 2, 0), and (6, 3, 0). Also, if the pointer is rotated counter-clockwise about the x-axis of the hand-held device's display then the endpoint of the pointer will be moved on the yz-plane of the cube, respectively, on nodes (0, 0, 1), (0, 0, 2), (0, 0, 3), (0, 0, 4), (0, 0, 5), (0, 0, 6), (0, 1, 6), (0, 2, 6), and (0, 3, 6).

Each spot in the 3D virtual environment that may be targeted to interact with the pointer needs at least one node to be located inside it, where, this is it to enable reaching these spots when the pointer is rotated or moved in 3D on the hand-held device's display. Accordingly, it is possible, in some cases, to reduce the number of nodes to a minimum number that is equal to the number of the targeted spots.

In case of presenting objects such as 3D mountains or 3D cartoon characters on the hand-held device's display, where these objects are hard to be divided by said intersected hidden lines that are parallel to the x, y, and z-axis, in this case, the curves or the free lines will be used instead of the straight lines to form the mesh grid that suites the configuration of such objects.

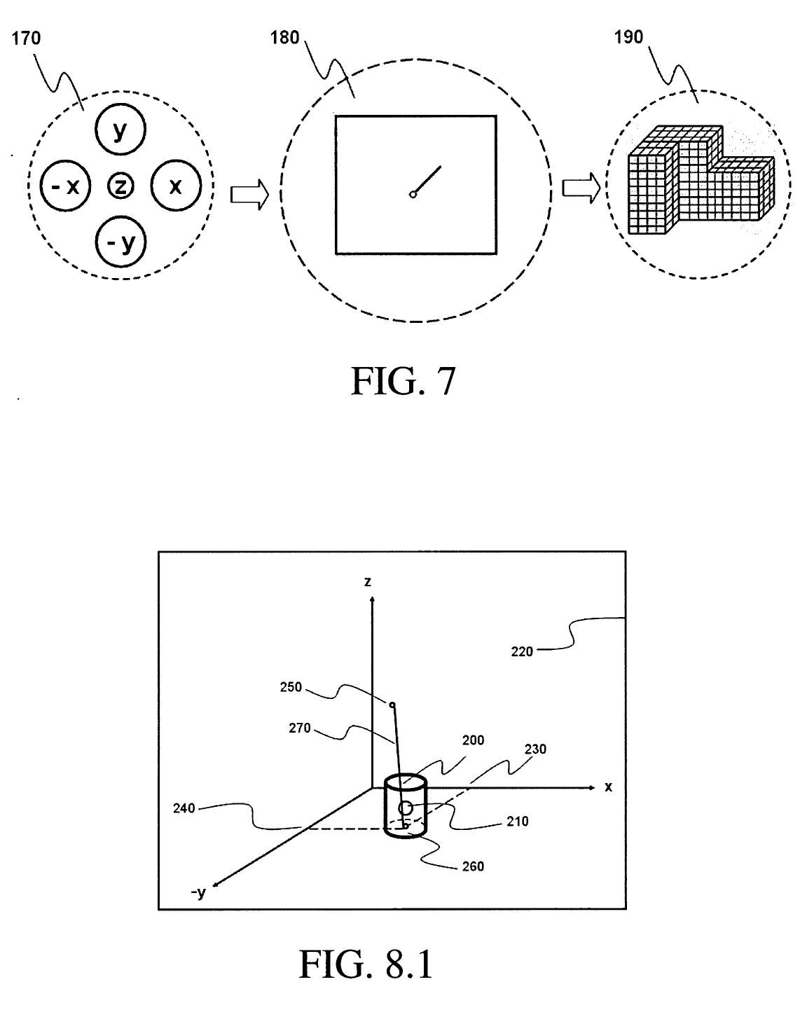

FIG. 7 is a diagrammatic illustration for the main three elements of the present invention: the first element is the 3D input method 170 that provides six degrees of freedom. The second element is the pointer 180 which is moved or rotated on the hand-held device's display to target a specific spot in a 3D virtual environment. The third element is the mesh grid 180 that the pointer moves on to reach its target in the 3D virtual environment on the hand-held device's display.

As mentioned previously, the five positions can be five spots on a touch screen such as that of the iPhone, where the user can move or tap his/her finger on the touch screen the same way s/he moves and presses his/her finger on the 5-wy button. This finger movement or tapping can be on any spot of the touch screen opposite to the 5-way button that has a fixed position for operation.

The main advantage of using the touch screen is the possibility of displaying the 3D cross of FIG. 2 on the hand-held device's display to indicate the user's finger rotation or movement. For example when the user provides a rotation about the x, y, or z-axis, the 3D cross rotates, respectively, about its x, y, or z axis on the hand-held device's display. Also, when the user provides a movement along the x, y, or z axis, the 3D cross indicates a mobile arrow or a colored strip, respectively, on its x, y, or z-axis on the hand-held device's display.

Another alternative for the 5-way button is utilizing adjacent five buttons arranged in a symmetrical cross-configuration on the hand-held device's keyboard of a cell phone, GPS unit, laptop, or the like. For example, in a cell phone's keyboard; the “6”, “4”, “2”, “8”, and “5” buttons can represent, respectively, the +x, −x, +y, −y, and z positions of the 5-way button. Also, the K, H, U, N, and J buttons of a laptop keyboard can represent the same five positions of 5-way button.

In these cases, there is a need to generate a unique signal to the computer system to indicate that the aforementioned buttons will start or finish functioning as a 5-way button, whereas this unique signal can be generated by pressing on two buttons simultaneously, such as the “Ctrl” button and the “5” button of the laptop keyboard.

The present invention can be used for the computer too, where in this case the 5-way button will be incorporated onto the top of a regular mouse to provide six degree of freedom. The present pointer will be integrated with the computer cursor where the computer cursor is moved on the computer display regularly, but when the 5-way button starts to provide six degrees of freedom then the present pointer appears on the computer display from the position of the cursor. In such case, it is possible to make the computer system calculate the point of intersection between the pointer's line and the planes of the 3D virtual environment instead of using the mesh grid, where this point of intersection represents the endpoint of the pointer.

In the previous examples the present pointer and the virtual camera were rotated simultaneously about the x and y-axis on the hand-held device's display, however, it is possible to rotate the present pointer independently about the x, or y-axis without rotating the virtual camera as follows;

Pressing once on the “x” position to rotate the pointer clockwise about the y-axis, and pressing once on the “−x” position to rotate the pointer counter-clockwise about the y-axis. Pressing once on the “y” position to rotate the pointer clockwise about the x-axis, and pressing once on the “−y” position to rotate the pointer counter-clockwise about the x-axis. When the user presses once to rotate the pointer independently, the time period of this pressing is different from the time period of the first pressing of the two tables of FIGS. 3 and 4. This difference is to enable the hand-held device to distinguish the need of the user to rotate the pointer independently.

Generally, the previous examples illustrate using the present invention to target objects in the 3D virtual environment on the hand-held device's display, however, it is possible to utilize the present invention to move or rotate said objects in 3D on the hand-held device's as follows;

The user presses twice on the “z” position of the 5-way button to indicate that the provided input of the 5-way button represents moving objects in 3D. In this case the six degrees of freedom will represent a movement along or a rotation about the x, y, or z-axis of the 3D virtual environment. To return back to the default mode of targeting objects the user presses twice on the “z” position to indicate that the provided input of the 5-way button represents targeting objects.

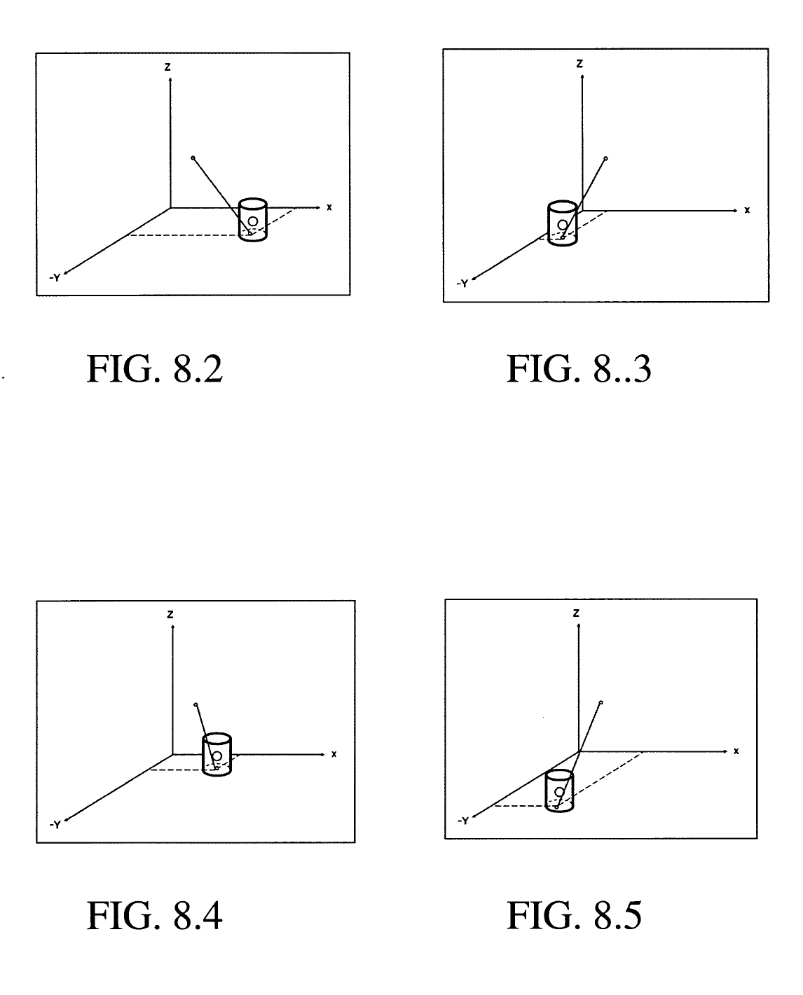

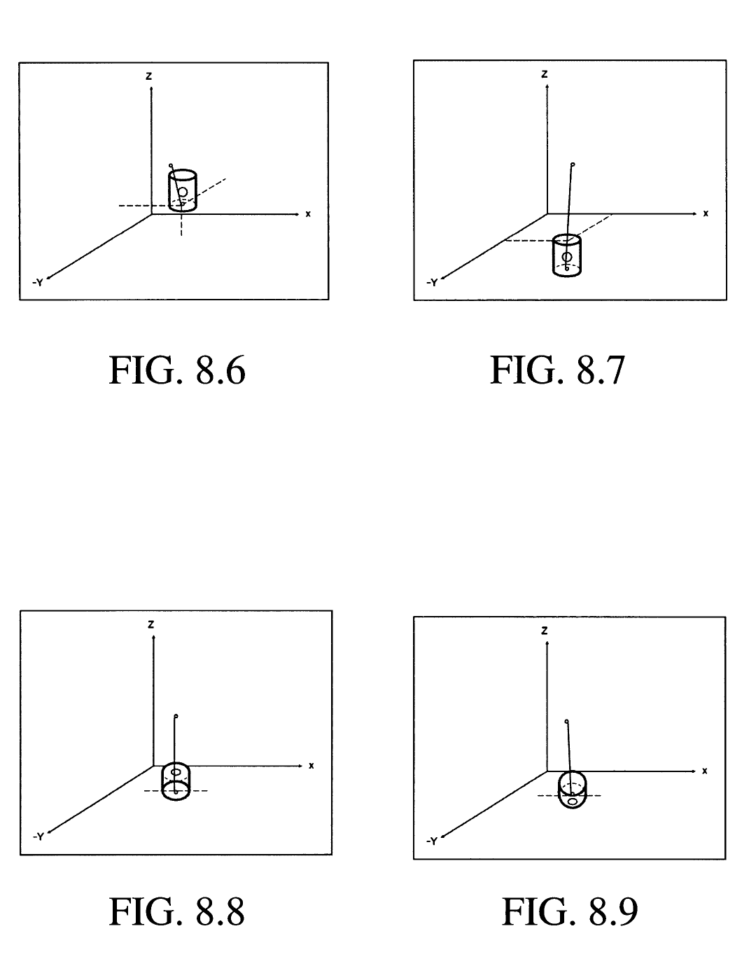

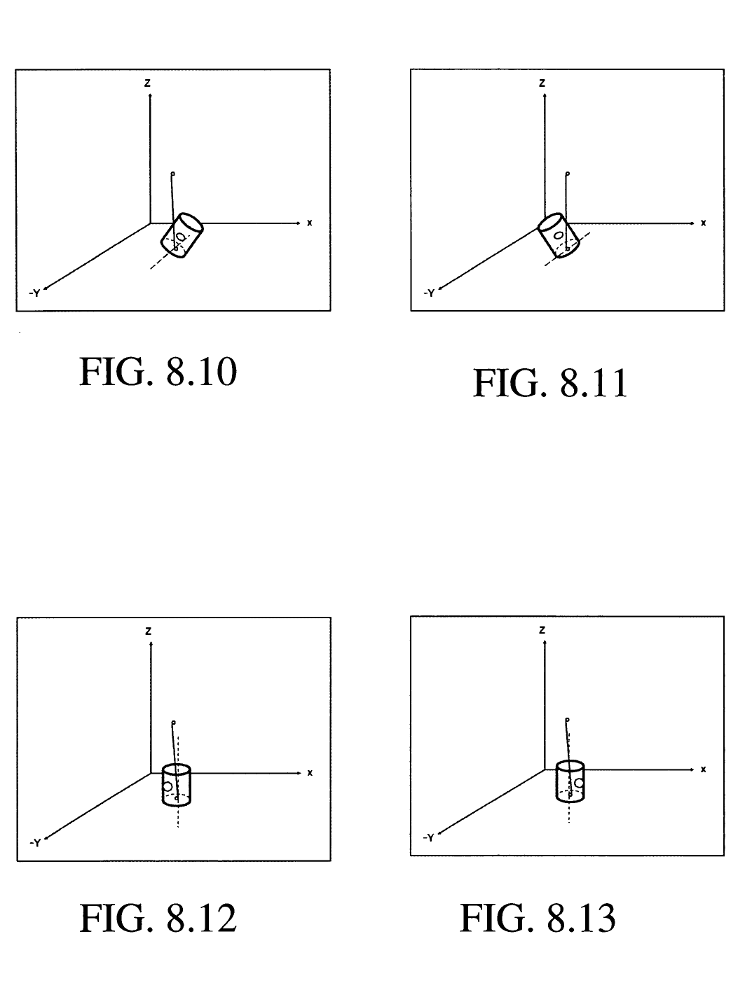

FIG. 8.1 illustrates a cylinder 200 with a hole 210, where the cylinder is positioned on the xy-plane of a 3D virtual environment on a hand-held device's display 220. There are two dotted lines 230 and 240 that indicate the distance between the center of the lower base of the cylinder and the x and y-axis. The base-point of the pointer 250 is located in the center of the hand-held device's display; the endpoint of the pointer 260 is targeting the center of the lower base of the cylinder, and the pointer line 270 connecting its base-point and endpoint.

FIGS. 8.2 and 8.3 illustrate moving the endpoint to move the cylinder, respectively, parallel to the positive and negative x-axis when the 5-way button provides a movement along the positive or negative x-axis. FIGS. 8.4 and 8.5 illustrate moving the endpoint to move the cylinder, respectively, parallel to the positive and negative y-axis when the 5-way button provides a movement along the positive or negative y-axis. FIGS. 8.6 and 8.7 illustrate moving the endpoint to move the cylinder, respectively, parallel to the positive and negative z-axis when the 5-way button provides a movement along the positive or negative z-axis.

FIGS. 8.8 and 8.9 illustrate rotating the pointer to rotate the cylinder, respectively, clockwise or counter-clockwise about the x-axis when the 5-way button provides a clockwise rotation or a counter-clockwise rotation about the x-axis. FIGS. 8.10 and 8.11 illustrate rotating the pointer to rotate the cylinder, respectively, clockwise or counter-clockwise about the y-axis when the 5-way button provides a clockwise rotation or a counter-clockwise rotation about the y-axis. FIGS. 8.12 and 8.13 illustrate rotating the pointer to rotate the cylinder, respectively, clockwise or counter-clockwise about the z-axis when the 5-way button provides a clockwise rotation or a counter-clockwise rotation about the z-axis.

The previous examples describe two major applications for the present invention, the first application is targeting objects in 3D, and the second application is moving objects in 3D. Another major application for the present invention is navigating in 3D on the hand-held device's display, where such application is vital for using 3D GPS, virtual reality and 3D games.

Generally, to control moving the virtual camera to navigate in 3D on the hand-held device's display, the direction of the pointer in 3D will be utilized as a direction for the virtual camera's orientation. This function enables the user to accurately view the end path of the virtual camera, which is the position of the endpoint of the pointer, before reaching this position. However, to activate this function the user will press on the “z” position three times before s/he starts to indicate that the provided input of the 5-way button represents a 3D navigation.

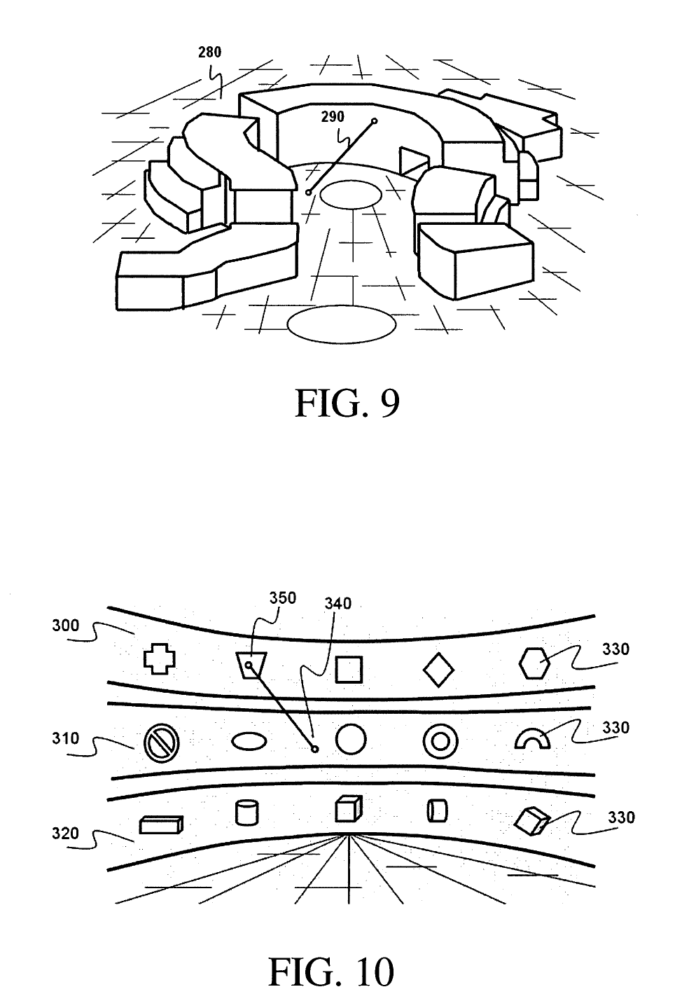

FIG. 9 illustrates an example for a virtual reality application on a hand-held device's display, where this figure shows a 3D modeling 280 for a site that includes buildings and landscape. There is a pointer 290 targeting a spot on one of said buildings where the direction of the pointer indicates the virtual camera's orientation at this moment of navigation. It is important to note that; in such example the user will not have the projection illusion problem that is very common when the virtual reality application is used on the computer display, since using the present pointer solves this problem.

FIG. 10 illustrates another innovative 3D application using the present invention, where this figure shows a 3D interface comprised of three cylindrical strips 300, 310, and 320; each one contains a number of icons 330. The base-point of the pointer 340 is located on the axial center of the cylindrical strips in the center of the hand-held device's display, and the endpoint of the pointer 350 is targeting one of these icons. As explained previously there is a node inside each icon to enable the endpoint of the pointer to target these different icons.

In this case, the user of the hand-held device can rotate the pointer to target any icon in any of the three cylindrical strips, move any icon from one strip to another to re-arrange the groups of the icons in each cylindrical strip, rotate any of the three cylindrical strips horizontally, or navigate in 3D to move the virtual camera to reach and penetrate any icon; if this icon functions as an opening that leads to a 3D virtual environment beyond the three cylindrical strips.

Another important application for the present invention is to enable the user of the hand-held device to interact with different 3D games. For example in shooting games the pointer can control the direction in which the player's head faces while aiming or shooting. Also, in flying games the user can control the different 3D rotations of various air-vehicles such as airplanes of rockets using the present 5-way button or its alternatives.

Overall, the main advantage of the present invention is utilizing an existing technology, where most of the hand-held device's keyboard include a 5-way button that can be utilized to provide six degrees of freedom using the method of the present invention. Also, most of the hand-held device's keyboards include adjacent five buttons arranged in a cross-configuration that can be used as alternatives for the present 5-way button as previously described.

In case of manufacturing a hand-held device mainly for the present invention, one alternative for the 5-way button is to use an analog sensor with its printed circuit board (“PCB”) as known in the art, where in this case, the PCB will process raw analog signals and convert them into digital signals that can be used for a microprocessor of computer system.

In this case, as long as the second pressed position (that is shown in FIGS. 3 and 4) is pressed by the user's finger; the sensor continuously generates specific data corresponding to the period of time of the finger pressing, where the computer system utilizes this period of time of the finger pressing as a value of the movement along the x, y, or z-axis or as a value of the rotation about the x, y, or z-axis.

It is also possible to utilize a 5-way digital button with its printed circuit board (“PCB”). The digital sensor provides five independent digital ON-OFF signals in the directions of north, east, south, west, and downward where these directions are associated, respectively, with the +y, +x, −y, −x, and z positions of the 5-way button.

For example, if the user pressed on the “+x” position of the 5-way button, which is the “east” direction of the 5-way digital button, then a (0,1,0,0,0) signal is generated, and if the user then pressed on the “+y” position of the 5-way button, which is the “north” direction, then a (1,0,0,0,0) signal is generated. Accordingly the computer system translates these two positions pressing as a counter-clockwise rotation about the z-axis as described previously in the table of FIG. 4.

In this case the value of this counter-clockwise rotation, which means the rotational angle depends on the amount of time the user will keep the “+y” position of the 5-way button pressed, which is the “North” direction of the 5-way digital button, where the default is to return the digital sensors to the (0,0,0,0,0) state once the user releases.

1. A 3D input system that enables the user to interact with 3D applications on a device's display, where said 3D input system is comprised of;
a) a 5-way button that has five positions to press on where each two different successive pressings on one or two positions of said 5-way button generate two unique successive signals that represent one degree of the six degrees freedom.
b) a pointer on said device's display that targets a specific spot in a virtual 3D environment, where said pointer is comprised of a line connecting a base-point which is located in the center of said device's display, and an endpoint which intersects with said 3D virtual environment on said device's display.
b) a mesh grid which is a result of intersected hidden lines parallel to the x, y, and z-axis of said 3D virtual environment on said device's display, where each intersection is considered as one node, and each node is defined with a unique ID and an identified position in three dimensions.
Where said 5-way button provides six degree of freedom making said base-point move along or rotate about the x, y, or z-axis to step said endpoint from one node to another on said mesh grid.

2. The 3D input system of claim 1 wherein the first degree of freedom represents a movement along the x-axis of said device's display, the second degree of freedom represents a movement along the y-axis of said device's display, the third degree of freedom represents a movement along the direction of said pointer in 3D on said device's display, the fourth degree of freedom represents a rotation about the x-axis of said device's display, the fifth degree of freedom represents a rotation about the y-axis of said device's display, and the sixth degree of freedom represents a rotation about said pointer.

3. The 3D input system of claim 1 wherein the first degree of freedom represents a movement along the x-axis of said 3D virtual environment, the second degree of freedom represents a movement along the y-axis of said 3D virtual environment, the third degree of freedom represents a movement along the z-axis of said 3D virtual environment, the fourth degree of freedom represents a rotation about the x-axis of said 3D virtual environment, the fifth degree of freedom represents a rotation about the y-axis of said 3D virtual environment, and the sixth degree of freedom represents a rotation about the z-axis of said 3D virtual environment

4. The 3D input system of claim 1 wherein said 5-way button is five spots on a touch screen.

5. The 3D input system of claim 1 wherein said 5-way button is adjacent five buttons arranged in a symmetrical cross-configuration on a device's keyboard.

6. The 3D input system of claim 1 wherein said 5-way button is an input device that provides six degrees of freedom.

7. The 3D input system of claim 1 further the virtual camera's orientation of said device's display is moved or rotated simultaneously with said pointer.

8. The 3D input system of claim 1 wherein said intersected hidden lines parallel to the x, y, and z-axis are curves or free-lines.

9. The 3D input system of claim 1 wherein each spot in said 3D virtual environment that may be targeted by said pointer has at least one node of said nodes inside it.

10. The 3D input system of claim 1 wherein pressing once on one of said five positions rotates said pointer clockwise about the x-axis, pressing once on one of said five positions rotates said pointer counter-clockwise about the x-axis, pressing once on one of said five positions rotates said pointer clockwise about the y-axis, and pressing once on one of said five positions rotates said pointer counter-clockwise about the y-axis.

11. The 3D input system of claim 1 wherein the direction of said pointer in three dimensions controls the virtual camera's orientation of said device's display during navigating in three dimensions.

12. The 3D input system of claim 1 wherein said pointer controls the direction in which a player's head faces of a three dimensional game on said device's display.

13. The 3D input system of claim 1 wherein said 5-way button controls the 3D rotations of an air-vehicle of a three dimensional game on said device's display.

14. The 3D input system of claim 1 wherein said pointer is a regular computer cursor that turns to function as said pointer when said 5-way button provides on degree of said six degrees of freedom.

15. The 3D input system of claim 1 wherein said device is a computer and said 5-way button is a computer mouse that provides six degrees of freedom.

16. The 3D input system of claim 1 wherein said device is a computer that calculates the point of intersection between said pointer and the planes of said 3D virtual environment where this point of intersection represents said endpoint.

17. The 3D input system of claim 1 wherein said 5-way button employs an analog sensor.

18. The 3D input system of claim 1 wherein said 5-way button employs a digital sensor.

19. The 3D input system of claim 1 wherein said spot is an object, icon, menu, or the like on said device's display.

20. The 3D input system of claim 2 wherein the x-axis of said device's display represents the horizontal direction which means the east-west direction of said device's display, and the y-axis of said device's display represents the vertical direction which means the north-south direction of said device's display.
